(19) United States
(12) Patent Application Publication
(10) Pub. No.: US 2016/0250969 A1
(43) Pub. Date: Sep. 1, 2016

(54) VEHICLE MIRAGE ROOF

(71) Applicant: Ford Global Technologies, LLC, Dearborn, MI (US)

(72) Inventor: Adrian Nania, Rochester, MI (US)

(73) Assignee: FORD GLOBAL TECHNOLOGIES, LLC, Dearborn, MI (US)

(21) Appl. No.: 14/632,220

(22) Filed: Feb. 26, 2015

(51) Int. Cl. B60R 1/00; B60R 11/02; B60R 11/04

(52) U.S. Cl. CPC B60R 1/00; B60R 11/04; B60R 11/0229; B60R 2011/0282; B60R 2011/0028

(57) ABSTRACT

A vehicle system includes a camera configured to capture a live video feed of a view above a vehicle and a display panel configured to display the live video feed of the view above the vehicle in real time inside the vehicle. The display panel may be attached or adhered to the interior roof surface. In some instances, the display panel may be divided into multiple sections, and each selection may be selectively illuminated by a controller.

### BACKGROUND

Many vehicle owners enjoy moonroofs because they increase the amount of natural light that enters the passenger compartment. Moreover, in good weather, the moonroof can open to improve airflow in the passenger compartment. Accommodating the moonroof often includes redesigning the roof structure. Specifically, vehicle roofs have cross-members that provide structural support, and at least one cross member often runs through the area where the moonroof is located. That cross member must be removed, resulting in a reduced structural support. The roof must therefore be reinforced in other areas to compensate for the reduction in structural support.

### BRIEF DESCRIPTION OF THE DRAWINGS

FIG. 1 illustrates an example vehicle having a system for simulating a moonroof.

FIG. 2 illustrates an example interior surface of a vehicle roof where a display panel may be installed.

FIG. 3 illustrates an example interior surface of a vehicle roof with a display panel installed.

FIG. 4 illustrates an example interior surface of a vehicle roof with a display panel having multiple sections that can be independently illuminated by a controller.

FIG. 5 illustrates example locations on the vehicle body where cameras may be located to capture an image of an area above the vehicle to project on a display panel in the passenger compartment of the vehicle.

FIGS. 6A-6F illustrate example images captured by a camera that may be presented on the display panel.

### DETAILED DESCRIPTION

Not all moonroofs can open. For example, fixed moonroofs allow ambient light to enter the passenger compartment of the vehicle but do not open for, e.g., airflow purposes. Even if it can be opened, moonroofs are generally only opened in nice weather conditions. Accordingly, the most common benefit of having a moonroof is the addition of ambient light in the passenger compartment. If that light is not desirable, a shade can be drawn to darken the passenger compartment.

One way to provide the ambient light benefits of a moonroof without having to redesign the vehicle roof structure includes a vehicle system that simulates an opening in the roof. An example system includes a camera that is configured to capture a live video feed of a view above a vehicle. The system further includes a display panel that is configured to attach to an interior roof surface and display the live video feed of the view above the vehicle in real time inside the vehicle. When the ambient light is not desired, the display panel may be turned off to simulate the effect of closing a moonroof shade. Moreover, the display panel may have different sections that can be independently illuminated to, e.g., illuminate different areas of the passenger compartment.

Therefore, the proposed vehicle system can simulate ambient light in the passenger compartment, and therefore replace a moonroof, including a fixed moonroof or a moonroof that can be opened to vent air.

The elements shown may take many different forms and include multiple and/or alternate components and facilities. The example components illustrated are not intended to be limiting. Indeed, additional or alternative components and/or implementations may be used.

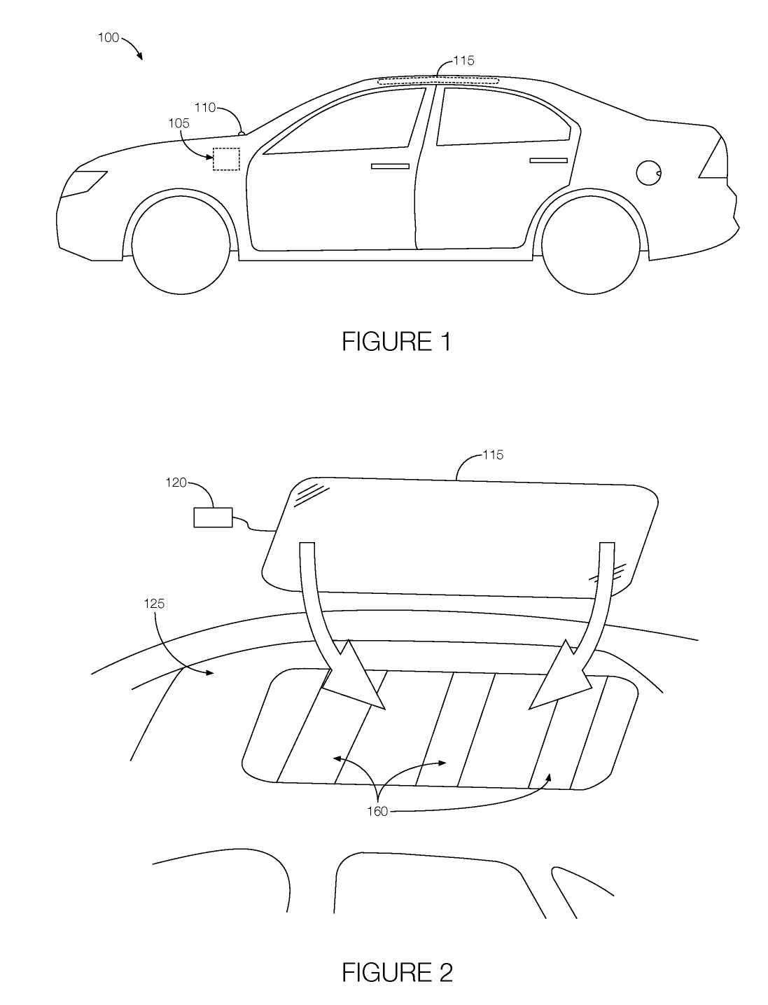

As illustrated in FIG. 1, a host vehicle 100 includes a display system 105 for simulating a moonroof or sunroof. Specifically, the display system 105 simulates the ambient light effects provided by a moonroof or sunroof. As shown, the display system 105 includes at least one camera 110, a display panel 115, and a controller 120.

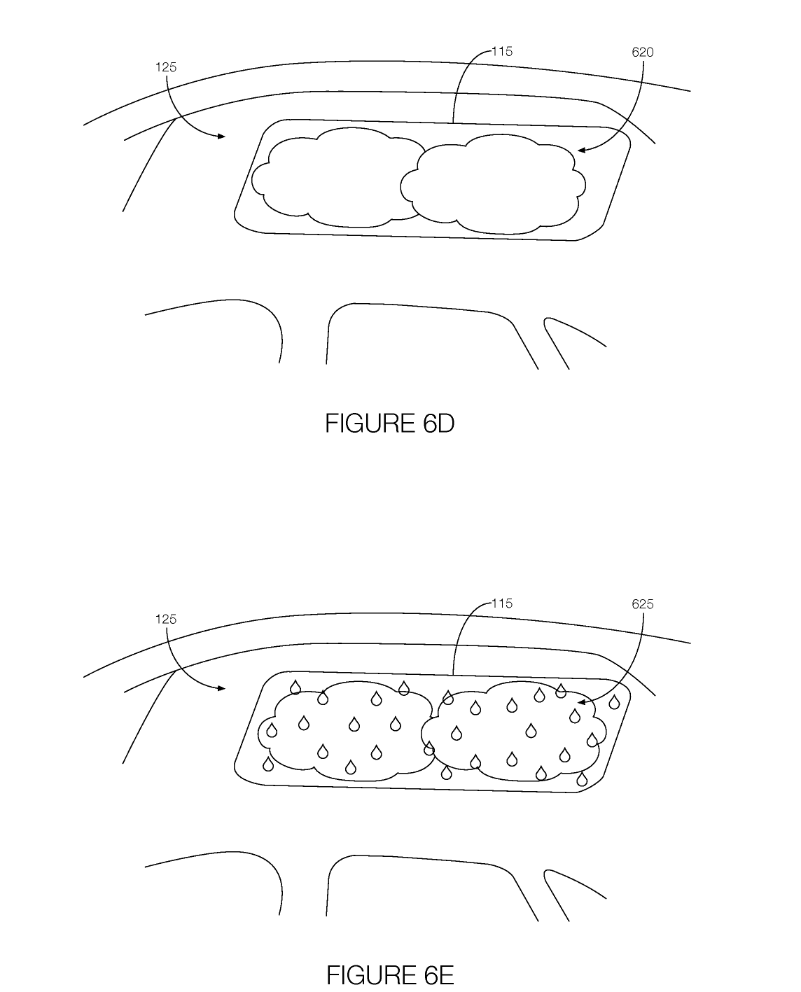

The camera 110 may include any computing device configured to capture a live video feed of a view above the host vehicle 100. The camera 110 may be configured and programmed to capture the live video feed and output a video signal representing the captured video. In some instances, the camera 110 may be programmed to process the video feed so that the video signal may be provided directly to the display panel 115. In other instances, the video signal may additionally or alternatively be processed at the display panel 115, the controller 120, or both. As discussed in greater detail below with respect to FIG. 5, the camera 110 may be mounted to an exterior surface of the host vehicle 100. Moreover, multiple cameras 110 may be used to capture the live video feed.

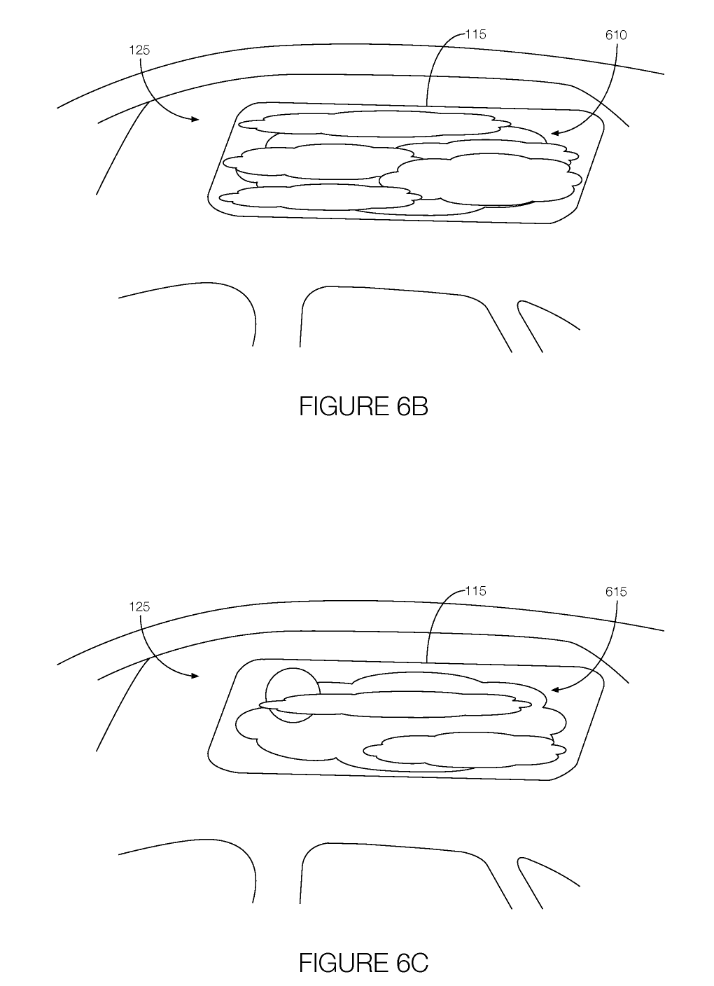

The display panel 115 may include any electronic device configured to present, in real time, the live video feed captured by the camera 110. The display panel 115 may be attached to an interior roof surface of the host vehicle 100. Therefore, the light generated by the display panel 115 may illuminate the passenger compartment of the host vehicle 100. The display panel 115 may be formed from a flexible material that, e.g., conforms to the shape of the interior roof surface. For example, the display panel 115 may be formed from a flexible liquid crystal display (LCD) sheet. In some instances, the flexible display panel 115 may be more shatter resistance than traditional materials used in a moonroof. The display panel 115 may include an array of pixels that can be selectively turned on or off. Each pixel may include different segments for showing different colors. For example, each pixel may include a red segment, a blue segment, and a green segment. By illuminating some or all of the segments, and by varying the intensity of each segment, each pixel may appear as a particular color. Groups of pixels may be controlled by, e.g., the controller 120, to present the live video feed captured by the camera 110 as represented by the video signal. As discussed in greater detail below with reference to FIG. 4, the display panel 115 may include multiple sections 130 that can be selectively illuminated.

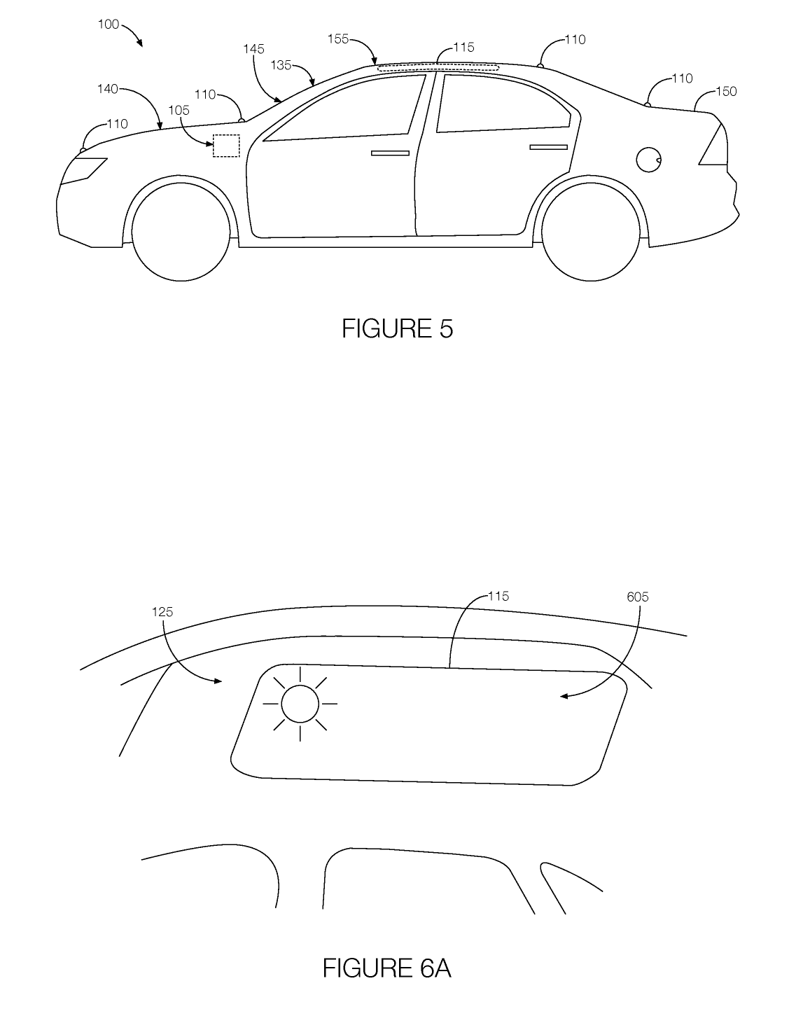

The display panel 115 may attach to the interior roof surface by, e.g., mounting the display panel 115 to the interior roof surface using mounting hardware, bonding the display panel 115 to the interior roof surface using an adhesive, or a combination of both. As discussed in greater detail below with respect to FIG. 3, the display panel 115 may be mounted or adhered to cross-members that structurally support the interior roof surface.

The controller 120 may include any computing device programmed to control the output of the display panel 115. For example, the controller 120 may be programmed to process the video signal and output a control signal that causes the display panel 115 to show the live video feed in real time inside the passenger compartment of the vehicle. Moreover, the controller 120 may be programmed to selectively illuminate the different sections 130 of the display panel 115, as discussed in greater detail below with respect to FIG. 4.

Although illustrated as a sedan, the host vehicle 100 may include any passenger or commercial automobile such as a car, a truck, a sport utility vehicle, a crossover vehicle, a van, a minivan, a taxi, a bus, etc. In some possible approaches, the host vehicle 100 is an autonomous vehicle configured to operate in an autonomous (e.g., driverless) mode, a partially autonomous mode, and/or a non-autonomous mode.

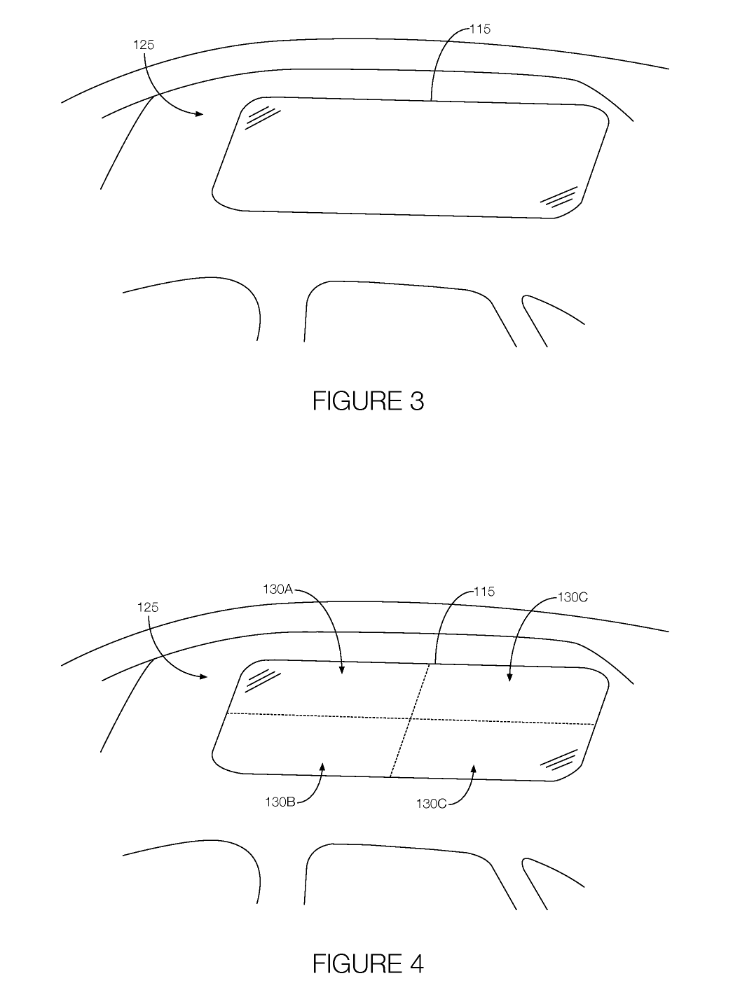

FIG. 2 illustrates an example interior surface 125 of the roof where the display panel 115 may be installed in the passenger compartment of the host vehicle 100. The interior surface 125 may include multiple cross-members 160. While three cross-members 160 are shown, the roof may include any number of cross-members 160 to provide structural support to the roof. The display panel 115 may be mounted or adhered to one or more of the cross-members 160. Because no cross-members 160 need to be removed to install the display panel 115, the roof of the host vehicle 100 does not need to be redesigned to accommodate the display system 105. Moreover, the display panel 115 can be installed as an aftermarket feature in vehicles that do not have a moonroof so long as the roof includes a sufficient number of cross-members 160.

FIG. 3 illustrates an example interior surface 125 of the roof with the display panel 115 installed. In some instances, the edges of the display panel 115 may be hidden by the headliner to be more aesthetically pleasing. That is, hiding the edges with the headliner may give the display panel 115 a more seamless appearance, as well as emulate, from the passenger compartment, the look of a traditional moonroof in a closed position. Moreover, as shown, the display panel 115 is long and wide enough to extend across almost the entirety of the interior surface 125 of the roof. Therefore, passengers in the front and rear seats can enjoy the live video feed or at least the ambient lighting effect resulting from the live video feed. If no ambient light is desired, or if one of the occupants does not wish to view the live video feed, the display panel 115 may be turned off via, e.g., an input provided to a user interface device. The user input may be transmitted to the controller 120, which may be programmed to turn off the display.

FIG. 4 illustrates an example interior surface 125 of the roof with the display panel 115 having multiple sections 130 that can be independently illuminated by a controller 120. Four sections 130A-D are shown in the example display panel 115 of FIG. 4. The display panel 115 may include any number of sections 130, however. Further, the lines of demarcation are for purposes of illustrating how the sections 130 may be divided. The actual lines may not be viewable to an occupant when the display panel 115 is turned on or off.

The sections 130 may include a first front section 130A, a second front section 130B, a first rear section 130C, and a second rear section 130D. The first front section 130A may generally illuminate the area near the driver seat. The second front section 130B may generally illuminate the area near the front passenger seat. The first rear section 130C may generally illuminate the area near the rear seat behind the driver seat. The second rear section 130D may generally illuminate the area near the rear seat behind the front passenger seat. The controller 120 may be programmed to illuminate the sections 130 individually or in groups. Example groups may include front only illumination (i.e., only the first front section 130A and the second front section 130B may be illuminated), rear only illumination (i.e., only the first rear section 130C and the second rear section 130D may be illuminated), driver side only illumination (i.e., only the first front section 130A and the first rear section 130C may be illuminated), and passenger side only illumination (i.e., only the second front section 130B and the second rear section 130D may be illuminated). Another possible illumination scheme may include passenger only illumination (i.e., only the second front section 130B, the first rear section 130C, and the second rear section 130D) may be illuminated.

FIG. 5 illustrates example locations on the body 135 of the host vehicle 100 where the camera 110 may be located to capture the live video feed of the area above the host vehicle 100. For instance, the camera 110 may be located near the front of the hood 140 of the host vehicle 100, hear the area where the hood meets the windshield 145, or near the area where roof 155 meets the trunk lid 150 or hatch. In some instances, multiple cameras 110 at one or more of these locations may be used to capture the live video feed. Alternatively, only one camera 110 may be located on the body 135 of the host vehicle 100.

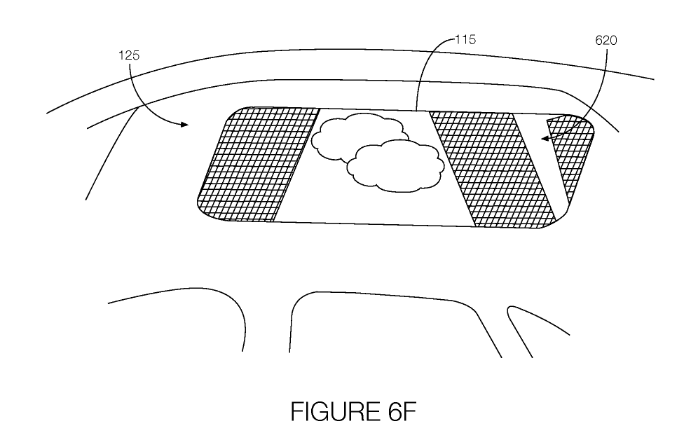

FIGS. 6A-6F illustrate example images that may be captured by the camera 110 as part of the live video feed that may be presented on the display panel 115. FIG. 6A illustrates an example image 605 that may be captured on a sunny day with relatively clear skies. FIG. 6B illustrates an example image 610 that may be captured near dusk. FIG. 6C illustrates an example image 615 that may be captured at night. FIG. 6D illustrates an example image 620 that may be captured on a cloudy day. FIG. 6E illustrates an example image 625 that may be captured on a rainy day. FIG. 6F illustrates an example image 630 that may be captured on a sunny day in an urban environment.

In general, the computing systems and/or devices described may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a camera configured to capture a live video feed of a view above a vehicle; and
a display panel configured to attach to an interior roof surface and display the live video feed of the view above the vehicle in real time inside the vehicle.

2. The vehicle system of claim 1, wherein the camera is configured to mount to an external surface of the vehicle.

3. The vehicle system of claim 1, wherein the display panel is formed from a flexible material and configured to conform to a shape of the interior roof surface.

4. The vehicle system of claim 1, wherein the display panel includes a plurality of sections.

5. The vehicle system of claim 4, further comprising a controller programmed to selectively illuminate at least one of the plurality of sections.

6. The vehicle system of claim 1, wherein the display panel is configured to be mounted to the interior roof surface.

7. The vehicle system of claim 1, wherein the display panel is configured to be bonded to the interior roof surface.

8. The vehicle system of claim 1, wherein the interior roof surface includes at least one cross member, and wherein the display panel is configured to attach to the at least one cross member.

9. A vehicle comprising:
a body at least partially defining a passenger compartment;
a roof disposed on the body and having an interior surface; and
a display system including a camera and a display panel, wherein the camera is disposed on an exterior surface of the body and is configured to capture a live video feed of a view above the body, and wherein the display panel is attached to the interior surface of the roof and configured to display the live video feed of the view above the body in real time inside the passenger compartment.

10. The vehicle of claim 9, wherein the display panel is formed from a flexible material and configured to conform to a shape of the interior surface of the roof.

11. The vehicle of claim 9, wherein the display panel includes a plurality of sections.

12. The vehicle of claim 11, wherein the display system includes a controller programmed to selectively illuminate at least one of the plurality of sections.

13. The vehicle of claim 9, wherein the display panel is mounted to the interior surface of the roof.

14. The vehicle of claim 9, wherein the display panel is bonded to the interior surface of the roof.

15. The vehicle of claim 9, wherein the roof includes at least one cross member, and wherein the display panel is attached to the at least one cross member.

16. A vehicle system comprising:
a camera mounted to an external surface of a vehicle and configured to capture a live video feed of a view above the vehicle; and
a display panel formed from a flexible material and configured to attach to an interior roof surface of the vehicle and display the live video feed of the view above the vehicle in real time inside the vehicle, wherein the display panel includes a plurality of sections; and
a controller programmed to selectively illuminate at least one of the plurality of sections of the display panel.

17. The vehicle system of claim 16, wherein the display panel is configured to be mounted to the interior roof surface.

18. The vehicle system of claim 16, wherein the display panel is configured to be bonded to the interior roof surface.

19. The vehicle system of claim 16, wherein the interior roof surface includes at least one cross member, and wherein the display panel is configured to attach to the at least one cross member.
